(19) United States
(12) Patent Application Publication
(10) Pub. No.: US 2010/0117907 A1
(43) Pub. Date: May 13, 2010

(54) DUAL-BAND ANTENNA

(76) Inventors: Jia-Hung Su, Tu-Cheng City (TW); Kai Shih, Tu-Cheng City (TW); Yu-Yuan Wu, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/269,631

(22) Filed: Nov. 12, 2008

(51) Int. Cl. H01Q 9/04

(52) U.S. Cl. 343/700 MS

(57) ABSTRACT

A dual-band antenna includes a first radiating portion, a second radiating portion and a third radiating portion. The second radiating portion includes a first section extending perpendicularly from a free end of the first radiating portion, and a second section extending substantially perpendicular to the first section and opposite to the first radiating portion from the first section. The third radiating portion includes a first segment extending in alignment with the first radiating portion from the free end of the first radiating portion, a second segment extending perpendicularly towards the second section from the first segment and spaced away from the first section and a third segment extending perpendicularly back to the first section from the second segment and spaced away from the second section. A feeding point is disposed at a junction of the first, second and third radiating portion.

### BACKGROUND OF THE INVENTION

1. Field of the Invention

The present invention relates to an antenna, and more specifically to a dual-band antenna.

2. The Related Art

More and more portable electronic devices such as personal computers, mobile phones and the like, use ranges of frequency between 5.1 gigahertz (GHz) and 5.8 GHz, and between 2.4 GHz and 2.5 GHz, incorporating IEEE802.11a/b provided by wireless local area network (LAN). Accordingly, there is a need to provide an antenna having at least dual band capability that can receive and transmit signal in both the 5.1-5.8 GHz and 2.4-2.5 GHz frequency ranges for meeting the development of the electronic industry.

Currently, there are many kinds of dual-band antennas or multi-band antennas designed to be compatible with the IEEE802.11a and the IEEE802.11b. Thereinto, a planar inverted-F antenna (PIFA), which has a compact structure, light weight, perfect impedance match, desired horizontal polarization and vertical polarization, is widely used in the portable electronic device. However, it is to be recognized that the shape of the PIFA, the size thereof and the like will have bad influence on the frequency bandwidth, efficiency and other characteristics of the PIFA when the PIFA is designed to show miniaturization and complanation. Therefore, it is not preferable to use the PIFA as a dual-band antenna to meet the present development demand.

### SUMMARY OF THE INVENTION

An object of the invention is to provide a dual-band antenna with compact structure having good performance of operation. The dual-band antenna adapted for being used in a portable electronic device includes a first radiating portion of an elongated shape, a second radiating portion and a third radiating portion. The second radiating portion includes a first section extending substantially perpendicularly from a free end of the first radiating portion, and a second section extending substantially perpendicular to the first section and opposite to the first radiating portion from a free end of the first section. The third radiating portion for generating a frequency band intersecting with a frequency band generated by the first radiating portion includes a first segment extending in alignment with the first radiating portion from the free end of the first radiating portion, a second segment extending substantially perpendicularly towards a substantially middle portion of the second section from a free end of the first segment and spaced away from the first section, and a third segment extending substantially perpendicularly back to the first section from a free end of the second segment and spaced away from the second section. A feeding point is disposed at a junction of the first, second and third radiating portion.

As described above, the structure of the dual-band antenna is simple and compact, which is easy to be manufactured and occupies a small space of a portable electronic device. Meanwhile, the third radiating portion generates an electrical resonance intersecting with an electrical resonance generated by the first radiating portion, which can enlarge frequency bandwidth of the dual-band antenna and consequently, improve receiving effect and efficiency of the dual-band antenna at wireless communication.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view illustrating the structure of a dual-band antenna of an embodiment in accordance with the present invention: and

FIG. 2 shows a Voltage Standing Wave Ratio (VSWR) test chart of the dual-band antenna shown in FIG. 1.

### DETAILED DESCRIPTION OF THE EMBODIMENT

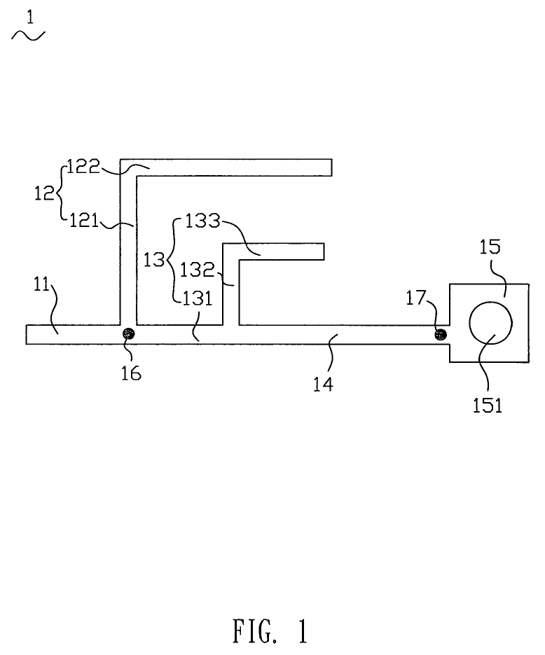

With Reference to FIG. 1, an embodiment of a dual-band antenna 1 according to the present invention is shown. The dual-band antenna 1 includes a first radiating portion 11 for high frequency. The first radiating portion 11 is an elongated shape. An end of the first radiating portion II is connected with a second radiating portion 12 for low frequency. The second radiating portion 12 coplanar with the first radiating portion II includes a first section 121 extending perpendicularly from the end of the first radiating portion 11, and a second section 122 bent opposite to the first radiating portion 11 from a free end of the first section 121. The first section 121 and the second section 122 are all prolonged shape and longer than the first radiating portion 11. The second section 122 is parallel to the first radiating portion 11 and substantially same as the first section 121 in length. A feeding point 16 is disposed at the conjunction of the first radiating portion 11 and the second radiating portion 12.

The first radiating portion 11 and the second radiating portion 12 are connected with a third radiating portion 13 at a common plane. The third radiating portion 13 for enhancing high frequency includes a first segment 131, a second segment 132 and a third segment 133. The first segment 131 is stretched a distance substantially same as the length of the first radiating portion 11, in alignment with the first radiating portion 11 from the end of the first radiation portion II adjacent to the second radiation portion 12. A free end of the first segment 131 is extended towards a substantially middle portion of the second section 122 to form the second segment 132. The second segment 132 is parallel to the first section 121 and has a height lower than the first section 121. The third segment 133 is bent back to the first section 121 from a free end of the second segment 132, paralleling the second section 122 with a predetermined distance therebetween. The second segment 132 and the third segment 133 are substantially the same as the first segment 131 in length. A free end of the third segment 133 is substantially flush with that of the second section 122.

The first segment 131 is lengthened opposite to the first radiating portion 11 to form a connecting portion 14. The connecting portion 14 is a strip shape and exceeds the third segment 133 with a long distance. A free end of the connecting portion 14 is connected with a rectangular fixing portion 15. The fixing portion 15 has a fixing aperture 151 thereon. A screw or other fastening device is inserted through the fixing aperture 151 to secure the dual-band antenna 1 to a portable electronic device (not shown). Additionally the connecting portion 14 has a grounding point 17 at the end thereof adjacent to the fixing portion 15.

When the dual-band antenna 1 operates at wireless communication, a current is fed from the feeding point 16 to the first radiating portion 11 to result in an electrical resonance corresponding to a quarter wavelength corresponding to 5.2 GHz frequency band, to the second section 122 to generate an electrical resonance corresponding to a quarter wavelength corresponding to 2.4 GHz frequency band, and to the third segment 133 to cause an electrical resonance corresponding to a quarter wavelength corresponding to 5.2 GHz frequency band. The electrical resonance generated by the first radiating portion 11 and the third radiating portion 13 intersects with each other so as to enlarge bandwidth of 5.2 GHz frequency band, consequently, improve receiving effect and increase the efficiency of the dual-band antenna 1.

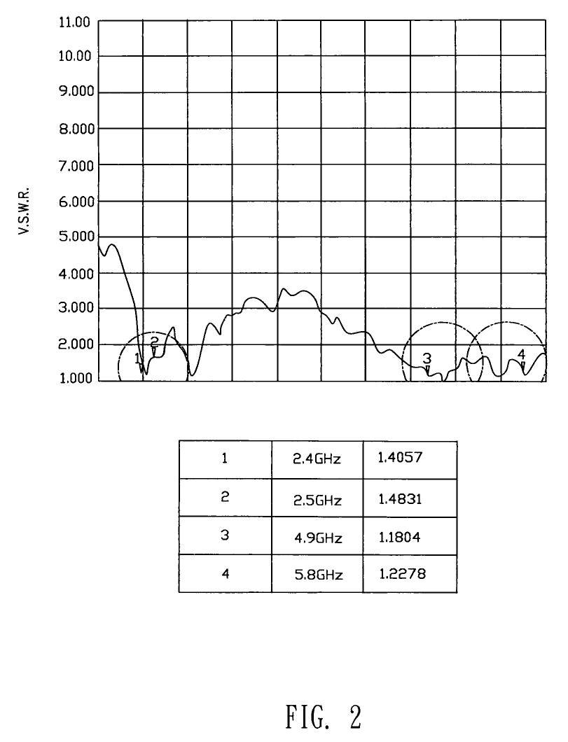

FIG. 2 shows a Voltage Standing Wave Ratio (VSWR) test chart of the dual-band antenna 1 when the dual-band antenna 1 operates at wireless communication. When the dual-band antenna 1 operates at a frequency of 2.4 GHz (indicator 1 in FIG. 2), the resulting VSWR value is 1.4057. When the dual-band antenna 1 operates at a frequency of 2.5 GHz (indicator 2 in FIG. 2), the resulting VSWR value is 1.4831. When the dual-band antenna 1 operates at a frequency of 4.9 GHz (indicator 3 in FIG. 2), the resulting VSWR value is 1.1804. When the dual-band antenna 1 operates at a frequency of 5.8 GHz (indicator 4 in FIG. 2), the resulting VSWR value is 1.2278. The VSWR values of the dual-band antenna 1 are all below 2, which means that the dual-band antenna 1 has excellent frequency response between 2.4 GHz and 2.5 GHz, and 4.9 GHz and 5.8 GHz.

As described above, the structure of the dual-band antenna 1 is compact and complanate, which is easy to be manufactured and occupies a small space of the portable electronic device. Meanwhile, the electrical resonance generated by the first radiating portion 11 and the third radiating portion 13 intersects with each other for enhancing higher frequency, which can expand frequency bandwidth of the dual-band antenna 1 so as to improve the receiving effect and efficiency. As a result, the dual-band antenna 1 has better performance of operation at wireless communication.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A dual-band antenna adapted for being used in a portable electronic device, comprising:
a first radiating portion of an elongated shape;
a second radiating portion including a first section extending substantially perpendicularly from a free end of the first radiating portion, and a second section extending substantially perpendicular to the first section and opposite to the first radiating portion from a free end of the first section;
a third radiating portion for generating an electrical resonance intersecting with an electrical resonance generated by the first radiating portion, the third radiating portion including a first segment extending in alignment with the first radiating portion from the free end of the first radiating portion, a second segment extending substantially perpendicularly towards a substantially middle portion of the second section from a free end of the first segment and spaced away from the first section, and a third segment extending substantially perpendicularly back to the first section from a free end of the second segment and spaced away from the second section; and
a feeding point disposed at a junction of the first, second and third radiating portion.

2. The dual-band antenna as claimed in claim 1, wherein a free end of the second section is substantially flush with that of the third segment.

3. The dual-band antenna as claimed in claim 1, further comprising a connecting portion extending in alignment with the first segment from the free end of the first segment, the connecting portion defining a grounding portion at a free end thereof.

4. The dual-band antenna as claimed in claim 3, wherein the free end of the connecting portion is connected with a fixing portion which has a fixing aperture for securing the dual-band antenna to the portable electronic device.
